(19) United States
(12) Patent Application Publication
(10) Pub. No.: US 2013/0199264 A1
(43) Pub. Date: Aug. 8, 2013

(54) FLUID BASED ANALYTE DETECTOR

(71) Applicant: Aya Seike, Shinjuku-ku (JP)

(72) Inventor: Aya Seike, Shinjuku-ku (JP)

(73) Assignee: EMPIRE TECHNOLOGY DEVELOPMENT LLC, Wilmington, DE (US)

(21) Appl. No.: 13/879,457

(22) PCT Filed: Sep. 13, 2011
(86) PCT No.: PCT/US11/51450

§ 371 Date: Apr. 15, 2013

(51) Int. Cl. G01N 30/62

(52) U.S. Cl. CPC G01N 30/62
USPC 73/23.4; 216/18

(57) ABSTRACT

A gas chromatograph having a gas inlet port, a sealed fluid flow channel, a gas outlet port, a gas outlet port in fluid connection with a second end of the fluid flow channel, and a gas molecule detector in fluid connection with the gas outlet port, is disclosed. The first end of the sealed fluid flow channel is in fluid connection with the gas inlet port. The sealed fluid flow channel contains one or more pairs of electrodes running lengthwise along the inner surface of the fluid flow channel.

### BACKGROUND

Unless otherwise indicated herein, the materials described in this section are not prior art to the claims in this application and are not admitted to be prior art by inclusion in this section.

To address the recent growing concern for environmental issues, air quality sensors have been widely used. Gas chromatography (GC) is a common type of chromatography which is used for separating and analyzing compounds that can be vaporized without decomposition. In the case of GC, for example, there have been various restrictions on the types of compounds. For example, separation and analysis of non-volatile chemical materials is not suitable. Because gas chromatography separates gas molecules by taking advantage of differences in the boiling points of materials, only volatile molecules can be handled.

GC instruments are typically operated at very high temperatures, leading to most separation columns being made of a metallic material, such as stainless steel. The high operating temperatures makes miniaturization of the instrument difficult.

Thus, conventional gas-molecule measuring devices such as GC devices are large and expensive. Typical GC devices have a capillary column including a gas separating mechanism. The typical length of the capillary column can be about 5 to 100 m, but it differs from design to design. However, these large-scale devices are not suitable for simple detection and/or measurement of gas-molecule in a portable and/or real-time manner. There remains a great need to miniaturize the separating mechanism while maintaining sufficient reliability.

### SUMMARY

In some embodiments, a gas chromatograph is provided. The gas chromatograph includes a gas inlet port, a sealed fluid flow channel containing one or more pairs of electrodes running lengthwise along the inner surface of the fluid flow channel, where a first end of the fluid flow channel is in fluid connection with the gas inlet port, a gas outlet port in fluid connection with a second end of the fluid flow channel, and a gas molecule detector in fluid connection with the gas outlet port. In some embodiments, the fluid flow channel is contained on a chip.

In some embodiments, the dimensions of the chip may be a length of about 500 μm or less, a width of about 500 μm or less, and a thickness of about 100 μm or less. The fluid flow channel may be at least about 1,000 μm in length.

In some embodiments the fluid flow channel may be microfabricated on a silicon substrate or a glass substrate. The gas molecule detector may be contained on the chip.

In some embodiments, the one or more pair of electrodes is located at opposite sides of the fluid flow channel. It is possible to contain two or more pairs of electrodes in the fluid flow channel. At least one of the electrodes may be a metal electrode.

In some embodiments, the fluid flow channel is vapor impermeable at all portions other than the gas inlet port and the gas outlet port. The length of the fluid flow channel can be at least about 1,000-fold greater than the largest cross-section of the fluid flow channel.

In some embodiments, the pair of electrodes is configured such that, when an alternating current is applied to the pair of electrodes, the migration pattern of a charged or polar molecule along the fluid flow channel is lengthened relative to the migration pattern of the charged or polar molecule along the fluid flow channel when no alternating current is applied to the pair of electrodes.

In some embodiments, the pair of electrodes is configured such that, when an alternating current is applied to the pair of electrodes, the migration pattern of a charged or polar molecule along the fluid flow channel is lengthened relative to the migration pattern of an uncharged, non-polar molecule under the same conditions.

In some embodiments, the gas chromatograph further includes a sample inlet port attached via a valve to the gas inlet port at a location upstream of the fluid flow channel. In some embodiments, the gas chromatograph further includes a carrier gas inlet port attached to the gas inlet port at a location upstream of the sample inlet port.

In some embodiments, the gas molecule detector includes a resistor circuit.

In some embodiments, a method of separating sample molecules is provided. This method includes providing a sample containing sample gas molecules, contacting at least a portion of the sample and a carrier gas to form a sample/carrier gas mixture, introducing the sample/carrier gas mixture into a fluid flow channel containing an inlet and an outlet, wherein the fluid flow channel contains at least one pair of electrodes running lengthwise along the inner surface of the fluid flow channel, applying an alternating current to the electrodes running lengthwise along the inner surface of the fluid flow channel, flowing the sample/carrier gas mixture from the fluid flow channel inlet to the fluid flow channel outlet while the alternating current is applied to the electrodes, and detecting the presence of sample gas molecules exiting the fluid flow channel outlet.

In some embodiments, the sample gas molecules can be separated according to their polarity and/or charged state or their molecular weight.

In some embodiments, the alternating current generates an electrical field approximately orthogonal to a fluid flow direction of the fluid flow channel.

In some embodiments, a method of producing a gas chromatograph is provided. This method includes providing a substrate, etching a channel in the substrate, wherein the channel includes an inlet and an outlet, depositing one or more pairs of electrodes on an inner surface of the channel, and sealing the channel.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a representative view of some embodiments of a scalable air quality sensor with a semiconductor device.

FIG. 2 depicts and example multi-layered structure of the column of the sensor.

FIG. 3A is a representative schematic diagram of some embodiments where a molecule migrates along a carrier gas flow between a pair of electrodes.

FIG. 3B is a representative schematic diagram of some embodiments where a molecule is attracted to an electrode given a positive voltage.

FIG. 3C is a representative schematic diagram of some embodiments where a molecule is repulsed by an electrode given a negative voltage.

FIG. 3D is a representative schematic diagram of some embodiments where a molecule migrates in a zigzag manner.

FIG. 4 is a representative schematic diagram of some embodiments showing trajectories of a molecule with a lower electronegativity and a molecule with a higher electronegativity migrating in a zigzag manner.

FIG. 5 is a representative schematic diagram of some embodiments showing trajectories of molecules of different masses migrating in a zigzag manner.

FIG. 6 is a graph of currents versus retention times of two kinds of molecules.

FIG. 7 is a representative schematic diagram of some embodiments where a particle can have a charge added thereto by coating with a charged surfactant.

FIG. 8A is a representative sectional view of some embodiments with one or more pair of electrodes charged.

FIG. 8B is a representative cross-sectional view of some embodiments with two pair of electrodes charged.

FIG. 8C is a representative cross-sectional view of some embodiments where two pair of electrodes charged.

FIG. 8D is a representative sectional view of some embodiments where electrodes are twisted.

FIGS. 9A-9E depict and example of manufacturing steps of the column.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Provided herein are various embodiments of systems and devices that can be used to sense a molecule. In some embodiments, this involves the use of a gas chromatograph associated with a fluid flow channel containing one or more pairs of electrodes running lengthwise along the inner surface of the fluid flow channel. A first end of the fluid flow channel is in fluid connection with the gas inlet port, a gas outlet port is in fluid connection with a second end of the fluid flow channel, and a gas molecule detector is in fluid connection with the gas outlet port. The device and/or system can be used with a sample molecule migrating along the direction of a carrier gas flow, and a migration trajectory of the sample molecule within the carrier gas can be controlled by the one or more pair of electrodes due to a Coulombic force between the sample molecule and the one or more electrodes. After migration through the fluid flow channel, the sample molecules can then be detected. In some embodiments, an alternating current can be applied to the one or more electrodes. This can assist in effectively speparating different molecules in a sample with high precision. In some embodiments, the fluid flow channel is contained on a chip. This can assist in effectively minituarizing the device/system in a portable manner.

In some embodiments, a method of separating molecules involves providing a sample containing sample molecules, contacting at least a portion of the sample molecules and a carrier gas to form a sample molecule/carrier gas mixture, introducing the sample molecule/carrier gas mixture into a fluid flow channel containing an inlet and an outlet, wherein the fluid flow channel contains at least one pair of electrodes running lengthwise along the inner surface of the fluid flow channel, applying an alternating current to the electrodes running lengthwise along the inner surface of the fluid flow channel, flowing the sample molecule/carrier gas mixture from the fluid flow channel inlet to the fluid flow channel outlet while the alternating current is applied to the electrodes, and detecting the presence of sample gas molecules exiting the fluid flow channel outlet.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

### Scalable Air Quality Sensing System

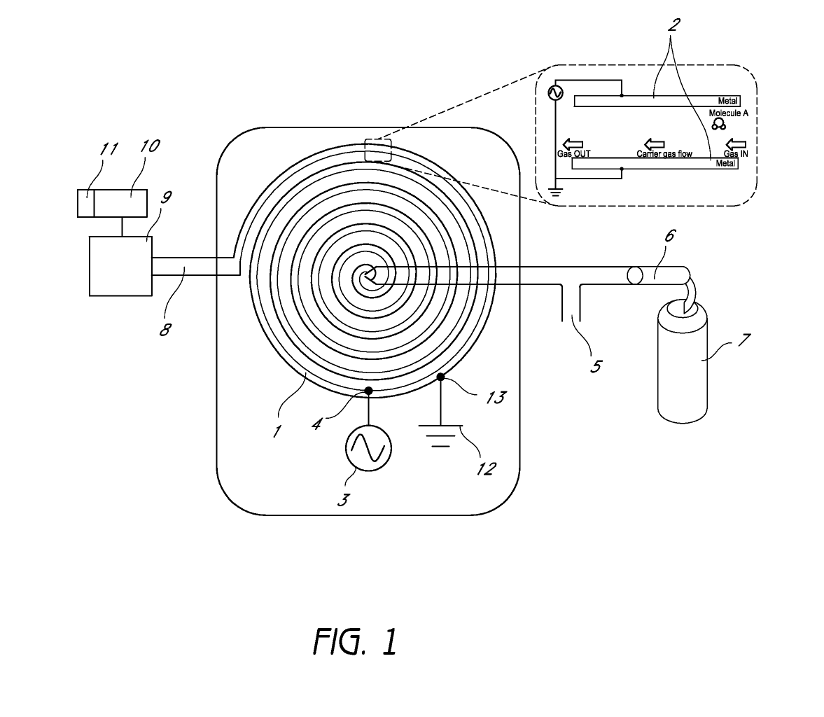

FIG. 1 shows an overview of one embodiment of scalable air quality sensing system using semiconductor devices. Here, a carrier gas from a carrier-gas cylinder 7 is introduced to a carrier-gas introducing port 6. The carrier gas is chemically inert, and may include, but is not limited to, helium, nitrogen, neon, argon, and hydrogen. The choice of the carrier gas is often related to the type of detectors used in the sensing system. The flow rate of the carrier gas may be typically controlled by a pressure regulator (not illustrated) and/or a flow controller (not illustrated) at the carrier-gas cylinder 7. The controlled flow rate of the carrier gas can be measured at a rotameter (not illustrated) after the flow controller. Once the flow rate of the carrier gas is controlled, the carrier gas is introduced through the carrier-gas introducing port 6. The carrier-gas introducing port 6 is coupled to a sealed fluid flow channel of column 1 and serves to introduce and transport the carrier gas to column 1.

A sample inlet port 5 is coupled to the sealed fluid flow channel of column 1, at a location downstream of the carrier-gas introducing port 6 and upstream of the sealed fluid flow channel. The sample inlet port 5 is used to introduce sample molecules to be analyzed into the sealed fluid flow channel of column 1. Any of a variety of known apparatuses for introducing a sample into a chromatograph can be used. In one embodiment, the sample inlet port 5 is an injector that shunts the flow of carrier gas through a sample-containing chamber such that the sample molecules are merged with the carrier gas and introduced into the sealed fluid flow channel of column 1.

In some embodiments, the sealed fluid flow channel of column 1 is composed of semiconductor materials, such as an insulating film of silicon, glass, a metallic thin film, and other materials suitable for microfabrication. Column 1 may be, formed in a shape of two-dimensional spiral, such as an Archimedean spiral (see, e.g., FIG. 1), which reduces the area occupied column 1 while keeping the column length sufficient for migration of samples to be separated. Alternatively, column 1 may be a pillar array column with low-dispersion turns where each turn has an outer boundary with a fixed radius and an inner boundary that gradually tapers toward the outer boundary prior to each turn. With the low-dispersion turns, it is possible to have the distance traveled by the sample molecules along inner and outer paths substantially the same. An example of a low-dispersion turn configuration can be seen in Aoyama et al., Anal. Chem. (2010) 82 1420-1426.

In some embodiments, column 1 is microfabricated on a silicon substrate or a glass substrate by using modified semiconductor device fabrication technology, such as microelectromechanical system (MEMS) technology. The MEMS technology permits miniaturization of column 1 to the submicron scale.

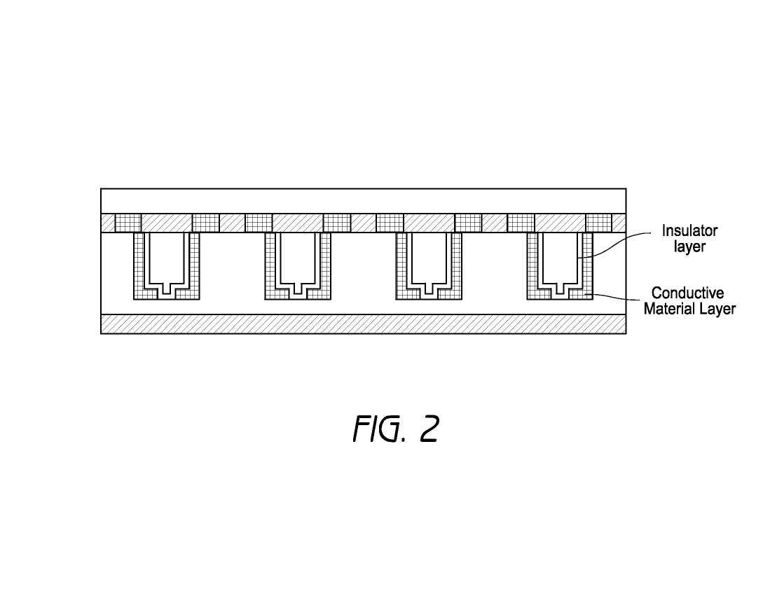

In some embodiments, one layer of column 1 is coated with a conductive material to serve as electrodes 2. For example this one layer can be the inner surface of column 1. Alternatively, in some embodiments, column 1 may have multi-layer structures. As illustrated in FIG. 2, for example, the layer structure of the column, from the most inner to the outer, can be composed of an insulator layer and, at least one conductive material layer. One of the electrodes 2 on the inner surface of column 1 is coupled to an alternating current power supply 3 via a node 4. The other of the electrodes 2 on the inner surface of the column may be coupled to the ground 12 via a node 13. The alignment of the electrodes may be varied, which will be described in greater detail hereafter. When an alternating current is applied to the electrodes 2, the electrodes 2 are given polarity. Here, a positive (+) electrode is considered as an anode and a negative (−) electrode can be regarded as a cathode, like in an electrolytic cell. Electrons enter between the electrodes 2 from the cathode and exit through the anode. This generates an electrical field between the electrodes 2, approximately orthogonal to a fluid flow direction of the fluid flow channel.

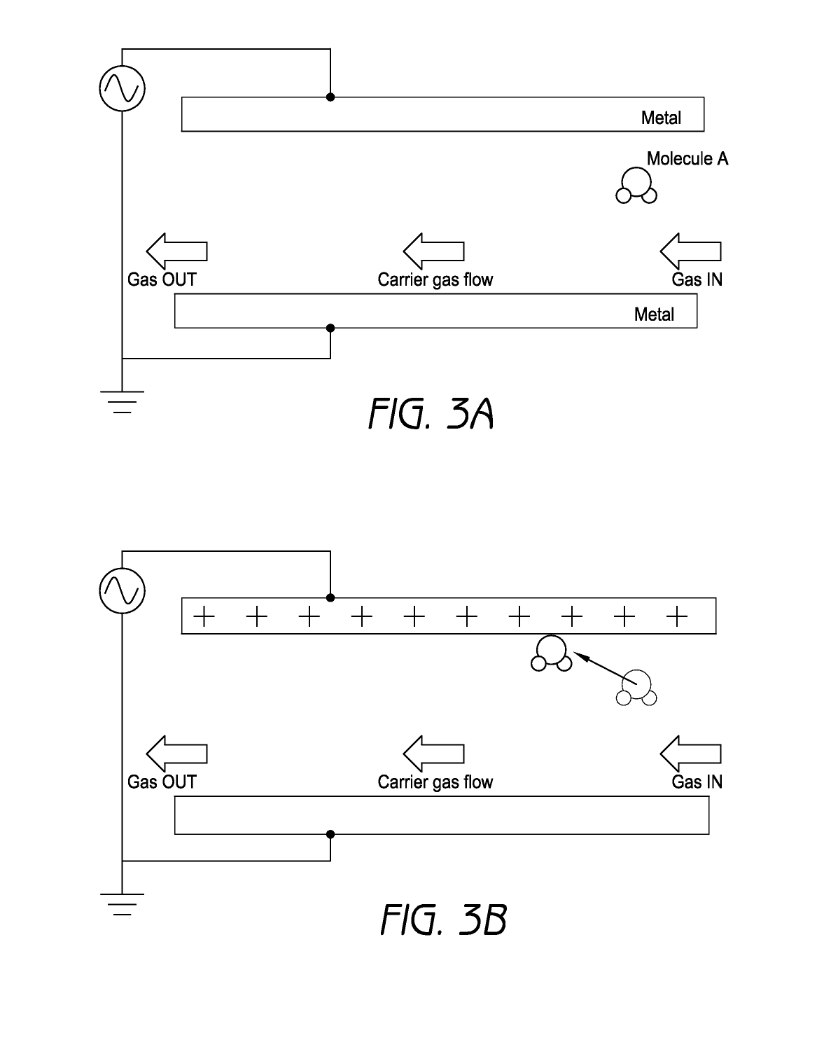

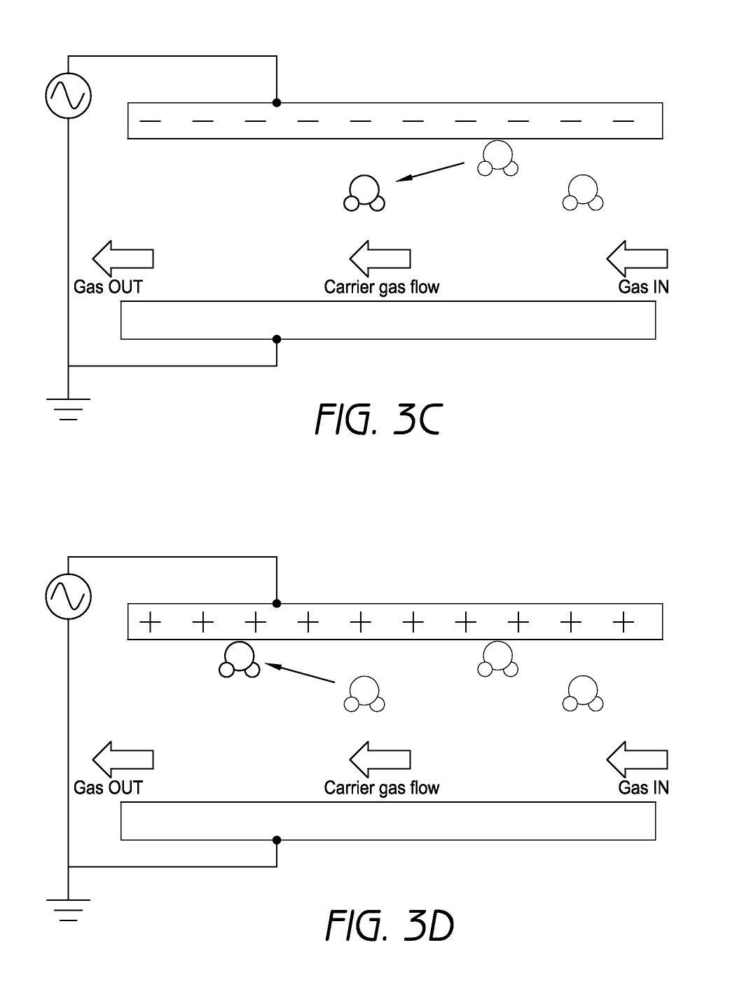

FIG. 3A shows some embodiments of the sample molecule analysis operation in the column 1. The carrier gas from the carrier-gas introducing port 6 transports the sample molecules from the sample inlet port 5 into and through column 1. Resulting the process of being transported through column 1, the sample molecule, shown as a molecule A in FIG. 1 migrates between the electrodes 2.

FIGS. 3B-3D illustrate behaviors of the sample molecule A in the generated electric field. The description here is along with the context of an example where molecule A is a polar or electronegative molecule. First, as shown in FIG. 3B, when a positive voltage is applied by the alternating current power supply, molecule A moves toward a positive electrode (+) side of the column, due to an electrostatic interaction between molecule A and the generated electric field. Second, as shown in FIG. 3C, when a negative voltage is applied to the inner surface of the column by the alternating current power supply, molecule A migrates away from the inner surface of the column due to repulsion from the generated electric field. When the positive voltage is applied again to the inner surface of the column by the alternating current power supply, as shown in FIG. 3D, molecule A is again attracted toward the inner surface of the column. By alternately applying positive and negative voltages with the alternating current power supply as described above, molecule A migrates through the column in a zigzag manner between the electrodes.

In some embodiments, it is possible to separate molecules individually having different values of polarity or electronegativity or different molecular masses, without limitation to volatile molecules. The degree of attraction to or repulsion from the column when the alternating current is applied relates to the electronegativity or dipole moment of the sample molecule and its molecular mass. When alternating positive and negative voltages are applied to the inner surface of the column, trajectories of the sample molecules are typically affected by the electrostatic interactions, resulting in a separation of sample molecules based on factors that include polarity, electronegativity and mass. This manner of sample resolution also is beneficial in that there is no volatility restriction on the types of samples that can be analyzed. For example, the sample molecules can be either volatile or nonvolatile, unlike gas chromatography which separates volatile gas molecules by taking advantage of differences in the boiling points of the molecules.

After travelling through the fluid flow channel of column 1 in a zigzag manner due to the electrostatic interaction and the flow of the carrier gas, the sample molecules reach gas outlet port 8 in FIG. 1. The gas outlet port is fluidly coupled to a second end of the fluid flow channel of column 1, where sample molecules in the carrier gas exit from the fluid flow channel of column 1.

Upon exit of the sample molecules from the fluid flow channel, the sample molecules are detected. In order to detect sample molecules, a molecule detector is fluidly coupled to gas outlet port 8. One example of the molecule detector includes a resistor circuit 9. In some embodiments, it is possible to mount a Wheatstone bridge circuit as the resistor circuit 9 for detecting the sample molecules. The resistor circuit 9 may be formed on the substrate on which the column is formed in such a manner that the column and the resistor are included in one chip.

In some embodiments, an integrated circuit 10 is coupled to the resistor circuit 9. The integrated circuit 10 evaluates changes in the current and voltage detected by the resistor circuit, at the time of collision of the sample molecules to the resistor circuit. The integrated circuit 10 may also be formed on the substrate on which the column is formed, similarly to the resistor circuit 9.

By designing a gas-molecule detecting chip including the column, the resistor and the integrated circuit, or any combination thereof and fabricating such chips by using a wafer having a large diameter, it is possible to minimize the size of the whole scalable air quality sensing system and the cost of the scalable air quality sensing system by introducing mass production.

In some embodiments, a communication system 11 that transfers result data obtained through calculation and evaluation by the integrated circuit 10 to an external server (not shown) is provided. The communication system may transfer the data either wirelessly or via wire. This communication allows the result data to be further examined and analyzed remotely outside the scalable air quality sensing system.

### Method of Separating and Detecting Molecules

In this section, methods of separating and detecting polar molecules introduced into the column when an alternating current is applied to the column will be described.

(1) Separating Molecules Having the Same Molecular Mass and Different Degrees of Electronegativity

When separating molecules having the same or approximately the same molecular mass and different degrees of electronegativity, it is possible to separate the molecules by applying an alternating current having an arbitrary frequency to electrodes while passing the molecules through a fluid flow channel.

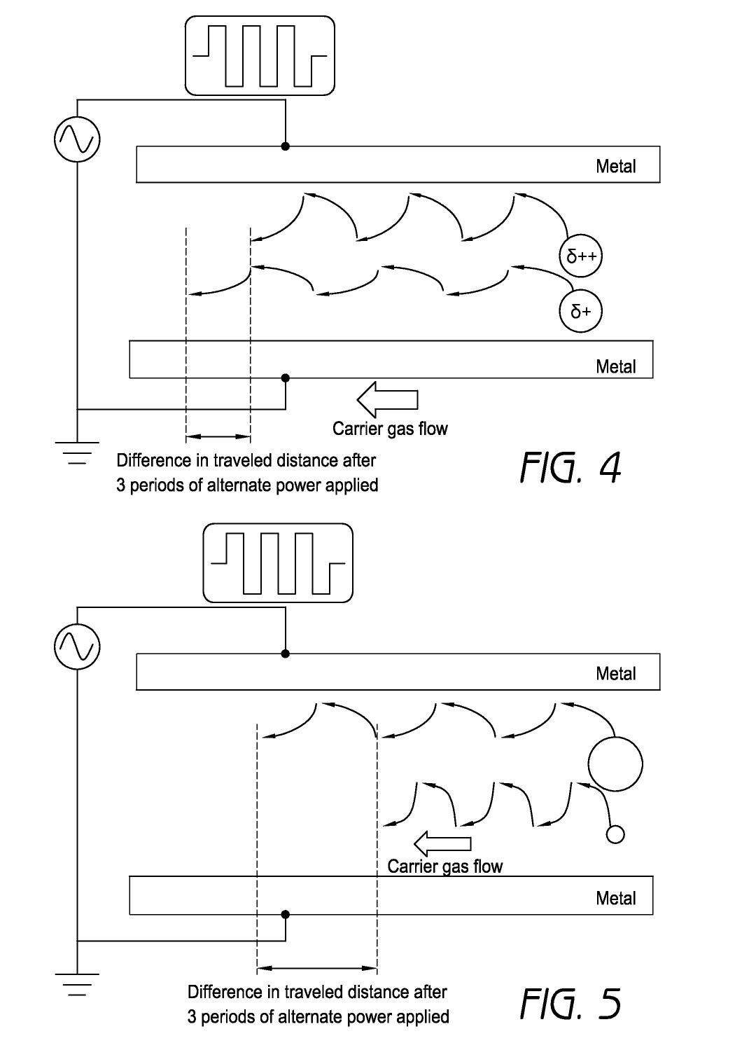

FIG. 4 is a schematic diagram, showing behaviors of molecules having the same molecular mass and different degrees of electronegativity, where three cycles of the alternating current is applied to the electrodes. The molecules migrate through the column in a zigzag manner between the electrodes due to the alternation between positive and negative voltages with the alternating current power supply. The molecules shown in the figure have different values of electronegativity (δ+, δ++). The molecule with a lower electronegativity (δ+) is less subject to perturbation by the electrodes due to its lower dipole moment and therefore migrates a longer distance. On the other hand, the molecule with a higher electronegativity (δ++) is subject to higher perturbation by the electrodes and therefore migrates a shorter distance than distance that the molecule with a lower electronegativity (δ+) moves. As a result, a difference occurs in the distance of migration when an alternating current with alternating positive and negative voltages having an arbitrary frequency is applied. Thus, it is possible to separate molecules having different dipole moments, by introducing sample molecules into a column and causing the sample molecules to migrate in a zigzag manner.

Mathematical representation of the separation of the polar molecules having different dipole moments, when an alternating current is applied to the column is described herein. A dipole moment is a measure of the polarity of a bond or molecule, due to non-uniform distributions of protons and electrons on the various atoms. A molecule with a permanent dipole moment is called a polar molecule such as acetone, water (H₂O), phenol, toluene, formamide, nitric oxide, and ethyl acetate. For polar molecules, an electric field E generated by the dipole moment can be expressed, for example, as in Equation (1). In Equation (1), p denotes the dipole moment, ε₀ denotes the vacuum permittivity, and z denotes the distance from the center of the dipole moment to the center of the electric field. Here, z is the distance at which a molecule is subjected to perturbation.

$$E = \frac{1}{2 {πɛ}_{0}} \cdot \frac{p}{{z}^{3}} \qquad ( 1 )$$

From Equation (1), the distance z can be expressed as in Equation (2).

$$z = \sqrt[3]{\frac{p}{2 {πɛ}_{0} E}} \qquad ( 2 )$$

For the fluid flow channel provided herein, the total perturbation distance of a given molecule subjected to perturbation along an arbitrary fluid flow channel length (L) can be expressed as in Equation (3). In Equation (3), f denotes the frequency (Hz) of the flow of molecules (particles) in the column, and v denotes the velocity (m/s) of the flow of molecules (particles) in the column.

$$Total perturbation distance = \frac{2 zfL}{v} \qquad ( 3 )$$

TABLE 1
Calculated total distances perturbed by molecules with different dipole
moments (Frequency: 10 kHz; Fluid flow channel length: 5,000 μm;
Flow velocity in the column: 1 m/s)

| | Dipole Moment | Perturbation Distance | Total distance |
|---|---|---|---|
| Molecules | (C²/N · m²) | (nm) | perturbed (nm) |
| Acetone | 1.00E−³¹ | 1.53 | 153 |
| H₂O | 6.20E−³⁰ | 6.06 | 606 |
| Phenol | 5.30E−³⁰ | 5.76 | 576 |
| Toluene | 1.30E−³⁰ | 3.60 | 360 |
| Formamide | 1.13E−²⁹ | 7.41 | 741 |
| Nitric oxide | 5.00E−³¹ | 2.62 | 262 |
| Ethyl acetate | 6.20E−³⁰ | 6.06 | 606 |

In Table 1, the total perturbation distance is shown in the case where the frequency is 10 kHz, the fluid flow channel length is 5,000 μm, and the flow velocity in the column is 1 m/s. This flow velocity in the column is a value typically used in a conventional type of electrostatic dust collector for introducing and capturing dust. For example, as shown in Table 1, with the fluid flow channel length of 5,000 μm, a distribution up to a range from 153 nm to 741 nm is attained. In the case of the fluid flow channel length of 5,000 μm, by adopting an Archimedean spiral shape as is understood from the fluid flow channel shape shown in FIG. 1, it is possible to accommodate the entire fluid flow channel inside a square having a size of 250 μm on each side, for example. Adopting this type of spiral shape, satisfactory resolution of polar molecules can be achieved while maintaining excellent miniaturization of the fluid flow channel.

Based on the relationship between the perturbation distances and the dipole moments of the sample molecules, the molecules having different dipole moments can be detected.

2) Separating Molecules Having Different Molecular Masses

In some embodiments, it is possible to identify sample molecules by measuring various frequency response characteristics of among different sample molecules.

For example, it is possible to separate molecules having different molecular masses and the same charge, or separate molecules having the same or approximately the same dipole moment by using a difference in frequency response characteristics. As shown in FIG. 5, when two molecules with the same charge, or two molecules with the same or approximately the same dipole moment, the molecule with a smaller molecular mass can be more strongly affected by the alternating current relative to the affect of the alternating current on a larger molecule. As a result, the smaller molecule tends to migrate in a more amplified zigzag manner relative to the larger molecule. This difference in migration results in the larger molecule advancing along the column more rapidly than the smaller molecule. Thus, it is possible to separate molecules having different molecular mass, by introducing sample molecules into a column and causing the sample molecules to migrate in a zigzag manner.

(3) Separation of Non-polar/Other Types of Molecules

As described above, this system typically uses the dipole moments of polar molecules to separate the molecules. However, it is possible to separate non-polar or other types of molecules by applying a charged compound to the sample molecules. Hereinafter, several methods for charging sample molecules can be described.

One example of this type of embodiment is a method adding an electrical charge to a non polar particle or non polar molecule by coating the non polar particle or non polar molecule with a charged surfactant as shown in FIG. 7. A suitable charged surfactant can include a cationic, anionic, or zwitterionic surfactant, where examples of a suitable charged surfactant include, but are not limited to, sodium dodecyl sulfate (also known as sodium lauryl sulfate), ammonium lauryl sulfate, sodium laureth sulfate (also known as sodium lauryl ether sulfate), sodium myreth sulfate, dioctyl sodium sulfosuccinate, perfluorooctanesulfonate, perfluorobutanesulfonate, alkyl benzene sulfonates, alkyl aryl ether phosphate, alkyl ether phosphate, alkyl carboxylates, sodium stearate, sodium lauroyl sarcosinate, perfluorononanoate, perfluorooctanoate, octenidine dihydrochloride, cetyl trimethylammonium bromide (as known as hexadecyl trimethyl ammonium bromide), cetyl trimethylammonium chloride, cetylpyridinium chloride, polyethoxylated tallow amine, benzalkonium chloride, benzethonium chloride, 5-Bromo-5-nitro-1,3-dioxane, dimethyldioctadecylammonium chloride, dioctadecyldimethylammonium bromide, 3-[(3-cholamidopropyl)dimethylammonio]-1-propanesulfonate), cocamidopropyl hydroxysultaine, amino acids, imino acids, cocamidopropyl betaine, and lecithin.

(4) Method of Detecting Molecules

In some embodiments, after sample molecules in the column migrate through the column in a zigzag manner and exit the column via a gas outlet port. The gas molecules can then be detected with a gas molecule detector, such as a resistor circuit, which can be coupled to the gas outlet port. From the evaluation result, it is possible to identify the sample molecules.

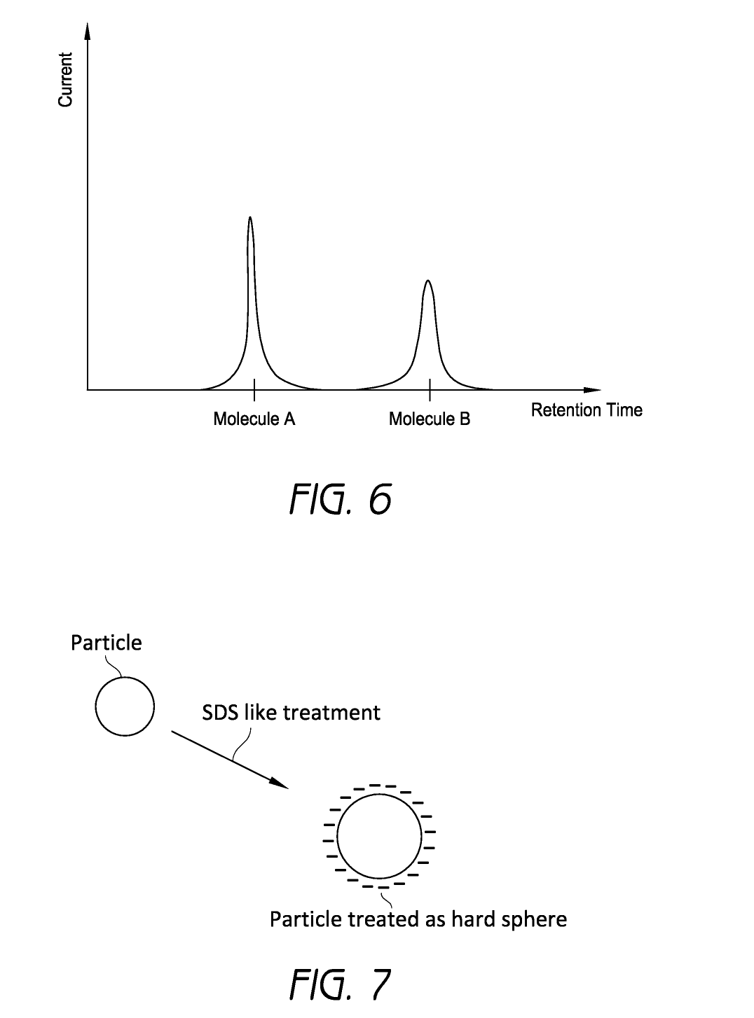

FIG. 6 shows detection using a resistor circuit, where changes in electric current indicate the presence of a sample molecule. In particular, FIG. 6 depicts the relationship between the measured electric current and retention time. The vertical axis represents an electric current that is observed when the sample molecule comes into contact with the resistor circuit, and the horizontal axis represents the time from introduction of the sample into the column until detection. In some embodiments, a non-polar type of noble gas such as helium can be used as the carrier gas. When sample molecules are separated based on differential electronegativity or dipole moments, the sample molecule having a lower electronegativity or dipole moment migrates in a zigzag manner with a smaller amplitude, so that the sample molecule migrates quickly through the column (see, e.g., FIG. 4). As a result the sample molecule having a lower electronegativity or dipole moment generates a peak in the electric current at an earlier time (e.g., “Molecule A” of FIG. 6). On the other hand, a peak in the electric current associated with the sample molecule with a higher electronegativity or dipole moment appears later with a longer retention time (e.g., “Molecule B” of FIG. 6).

In the case of FIG. 6, the magnitude relationship of the dipole moment is expressed as:

ρ_{A}<ρ_{B} (4)

In Equation (4), ρ_{A} (rho _{A}) denotes the dipole moment of molecule A and ρ_{B} (rho _{B}) denotes the dipole moment of molecule B. The integral value of each peak is proportional to the amount of the associated sample molecules detected. Furthermore, as expressed in equation (5), where CmA denotes the concentration of molecule A in the atmosphere, CmA is obtained by dividing the integral value of the detected peak of the molecule A by the result of subtracting the integrated value of the detected peak associated with the carrier gas from the total amount measured.

$$CmA = \frac{{\int }_{A} i d t}{{\sum }_{i = chemicals}^{n} ( \begin{matrix}{\int }_{Carriergas} i d t + {\int }_{i} i d t + \\ {\int }_{A} i d t + {\int }_{B} i d t + {\int }_{n} i d t\end{matrix} ) - {\int }_{Carrier} i d t} \qquad ( 5 )$$

In identifying a plurality of sample molecules, the sample molecules are identified based on retention times from the start of measurement to detection by gas molecule detector derived from the electric current measurement. In order to attribute an arbitrary peak to a chemical material, reference values of individual chemical materials are obtained.

In some embodiments, it is possible to store the results as reference data, and comparing measurement data with the reference data. After the scalable air quality sensing system is built, measurement of one or more kinds of samples may be performed to create a database of peak detection times of a plurality of chemical materials. Chemical materials can then be identified by comparing retention times observed at measurement with the peak detection times in the database.

In some embodiments, it is possible to improve the measurement precision by adjusting the length of a column. To prevent overlapping between the peak associated with the molecule A and the peak associated with the molecule B each other, the length of the column may be increased to cause the molecule with a higher dipole moment takes longer time to migrate through the column. As a result, by preventing overlapping between the peaks, measurement with improved precision becomes possible.

In some embodiments, it is possible to change the frequency of an alternating current, such as a low frequency for sample molecules with a low dipole moment and a high frequency for sample molecules with a high dipole moment. By adjusting the frequency of the alternating current according to a frequency of the sample molecules, it is possible to adjust the balance between improvement in measurement precision and reduction in measurement time.

In some embodiments, a function for sending data obtained through calculation in the integrated circuit in the system to an external server is provided. Thus, it becomes possible to send measurement data to an external agency for detailed evaluation of the data.

### Ionizer

An ionizer (ion source) is a device which ionizes molecules. Typical ionization of gas or vapor phase molecules can be conducted by electron ionization (electron impact). In the ion source, electrons are emitted from a heated filament and accelerated by a potential between the filament and a positive electrode to be an electron beam by being attracted to a trap electrode. A sample molecule is heated to have high temperature enough to produce a molecular vapor and introduced to the ion source in a direction perpendicular to the electron beam. Trajectories of the electron beam and the sample molecule intersect at a right angle, where collision and ionization occur. The electrons pass the molecule substantially close, the molecules close electrons by electrostatic repulsion, thus singly charged positive ions of the molecules are formed. The ionized molecules are then navigated towards to the sample inlet port, by a repeller electrode.

Alternatively, desorption sources, such as field desorption with high-potential electrode, electro spray ionization, or fast atom bombardment, may be used for non-volatile molecules.

### Manufacturing a Chip (Column, Electrode, Sensor)

In some embodiments, to achieve the preferable miniaturization of the scalable air quality sensing system, the column is microfabricated on a chip, having the dimensions of the chip as: length—about 500 μm or less; width—about 500 μm or less; and thickness—about 100 μm or less. The column may be microfabricated on, for example, a silicon, SiO₂, Ge, SiC, SiGe, III-V semiconductor, SiN, GaN, diamond, or aluminum oxide substrate. Alternatively, the column may be microfabricated on a substrate containing any other semiconductor materials which can be used for the substrate by using semiconductor device fabrication technology or modified semiconductor device fabrication technology, such as microelectromechanical system (MEMS) technology, or a nano-imprinting method including steps of deforming imprint resist, typically a monomer or polymer coated on a substrate. By the MEMS technology, miniaturization of the column into the submicron scale may be implemented. Embedding an integrated circuit 10, a resistor circuit 9, and a communication system on the same substrate may lead to further miniaturization.

Certain embodiments of methods of manufacturing a column for a scalable air quality sensing system on a substrate are described. First, a film is deposited on the substrate. Available technologies can include, but are not limited to, physical vapor deposition (PVD), chemical vapor deposition (CVD), atomic layer deposition (ALD), vacuum deposition, sputtering, etc. After the film deposition, a pattern of a channel including an inlet and an outlet is printed on the film to mask the channel. The printing process, such as lithography, may be followed by an etching process of removing some portions of the film to form the channel on the substrate. The etching process may be either wet etching or dry etching. Alternatively, chemical-mechanical planarization (CMP) may serve for etching. After the channel is formed, one or more pairs of electrodes are deposited on an inner surface of the channel. This deposition process can be performed any known method, such as by PVD, CVD or damascene process. In some embodiments, before or after the one more pairs of electrodes are deposited, the channel is subjected to a sealing step. In some embodiments, the sealed channel is vapor impermeable at all portions other than the inlet and the outlet.

Some embodiments include a step of coating the inner surface of the column with the conductive material. The conductive material which serves as the electrodes may be a metal. Alternatively, the column can be coated with glass, crystal, piezoelement, carbon, silicon, or any semiconductor material, for instance, polycrystalline silicon, carbon nanotubes, graphen, graphite, conductive polymers, etc.

In some embodiments, it is possible to connect one of the electrodes on the inner surface of the column to an alternating current power supply via a node. Further it is possible to connect the other of the electrodes on the inner surface to the ground (e.g., ground 12 in FIG. 1) via a node (e.g., node 13 in FIG. 1). The alignment of the electrodes may be varied, and this is described in greater details below.

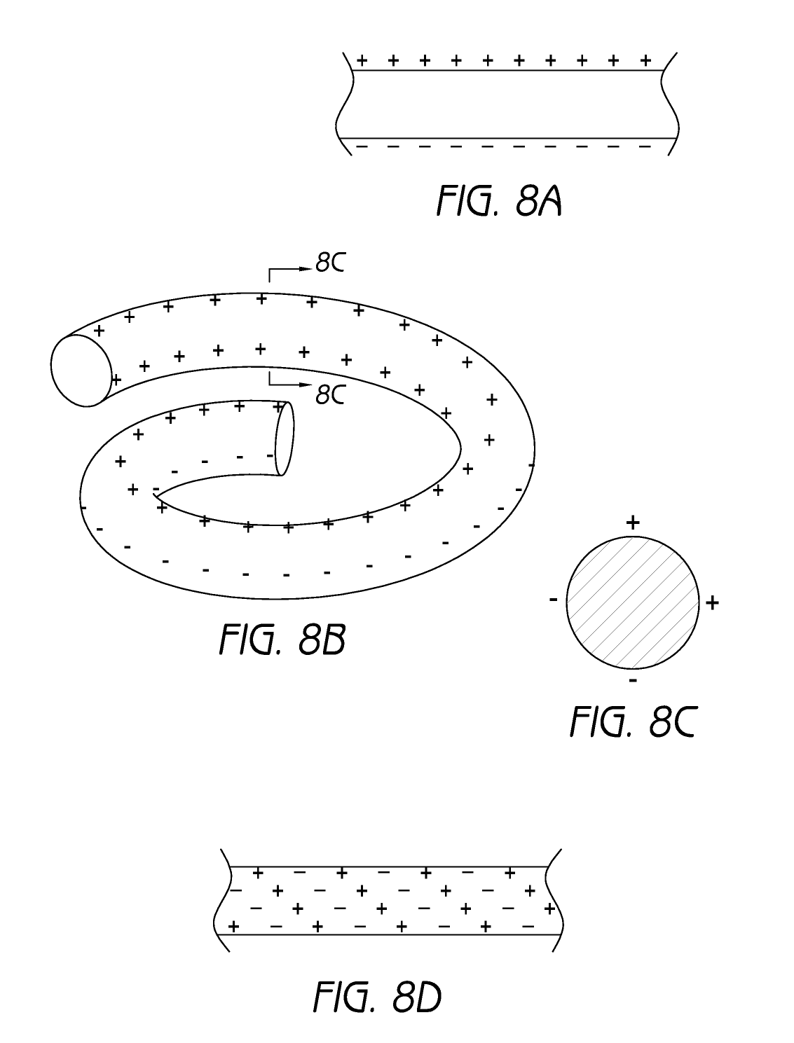

In some embodiments, the method may include forming one or more pairs of electrodes on the inner surface of the column 1. It is possible to arrange the electrodes in a longitudinal direction along the inner surface of the fluid flow channel as shown in FIG. 8A.

In some embodiments, using more pairs of metal electrodes may improve precision in controlling behaviors of the sample molecules. For example, two pairs of electrodes 2 may run on the inner surface of the column 1, having one pair of the electrodes having a positive electrode located on the top and a negative electrode located on the bottom, and the other pair of electrodes, having a positive electrode located on one side of the column, and a negative electrodes located opposite the positive electrode, as shown in FIG. 8B. FIG. 8C is a cross-sectional view of the column 1 shown in FIG. 8B. By arranging two pairs of electrodes, modulation of the migration pattern of the sample molecules can be controlled in two dimensions, not just in one dimension. Thus, this arrangement may improve control of the migration of the sample molecules, and can result in higher precision of molecule detection.

In some embodiments, the electrodes 2 may run on the inner surface of the column 1 in a spiral manner, as shown in FIG. 8D. The twisted two pairs of electrodes 2 generate twisted electric fields, which causes the sample molecules to migrate a longer distance along a twisted trajectory like a swirl. After whirling through the column 1 due to the gas alternating current, the sample molecules reach the gas outlet port 8 in FIG. 1. This twisted electrode arrangement can result in effectively lengthening the column, which can improves the resolution capability of the column, and thus improve precision in separating different molecules.

In some embodiments, it is possible to provide on the same chip as the chip containing the column, a molecule detector including a resister circuit 9 and an integrated circuit 10. For example, a Wheatstone bridge circuit, a Kelvin double bridge circuit or a potentiometer, may be mounted as the resistor circuit 9 in the chip for detecting the sample molecules for computing retention times of the sample molecules. In one embodiment, the method of manufacturing the chip may include forming the resistor circuit 9 and the integrated circuit 10 on the substrate on which the column is formed, in such a manner that the column and the molecule detector are included in one chip. In this chip, the molecule detector can be designed as a sensitive resistor such as an inorganic or organic based device, a field effect transistor (FET) with semiconducting layers and/or gates with chemical sensitivity, or a sensor based on the differential conductivity of nanotubes and nanowires. Therefore, by designing a molecule detecting chip including the column and the molecule detector, and fabricating such chips by using a wafer having a large diameter, compact size and mass production at low cost becomes possible.

### Methods of Sensing a Molecule

Provided herein are methods of sensing air quality by separating molecules. The method of separating molecules involves providing a sample containing sample molecules, contacting at least a portion of the sample molecules and a carrier gas to form a sample molecule/carrier gas mixture, introducing the sample molecule/carrier gas mixture into a fluid flow channel containing an inlet and an outlet, wherein the fluid flow channel contains at least one pair of electrodes running lengthwise along the inner surface of the fluid flow channel, applying an alternating current to the electrodes running lengthwise along the inner surface of the fluid flow channel, flowing the sample molecule/carrier gas mixture from the fluid flow channel inlet to the fluid flow channel outlet while the alternating current is applied to the electrodes, and detecting the presence of sample gas molecules exiting the fluid flow channel outlet. If the sample has a high concentration, it may be diluted with inert substance.

For example, a sample containing sample molecules can be provided from a sample inlet port. The sample inlet port is coupled to the fluid flow channel, and used to introduce sample molecules to be analyzed into the fluid flow channel. Any of a variety of known apparatuses for introducing a sample into a chromatograph can be used as the sample inlet port.

Here, a carrier gas, typically chemically inert, from a carrier-gas cylinder is introduced to a carrier-gas introducing port, at a location upstream of the carrier-gas introducing port. To control the flow rate of the carrier gas, a pressure regulator and/or a flow controller (not illustrated) are equipped at the carrier-gas cylinder. The controlled flow rate of the carrier gas can be further measured at a rotameter (not illustrated) after the flow controller. Based on the measurement, the flow rate of the carrier gas is further controlled, and the carrier gas is introduced through the carrier-gas introducing port at the controlled flow rate. The carrier-gas introducing port is coupled to the fluid flow channel and serves to introduce and transport the carrier gas the fluid flow channel.

By introducing the sample and the carrier gas, it is possible to shunt the flow of carrier gas through a sample-containing chamber which lets the sample molecules and the carrier gas contact, resulting in forming a sample molecule/carrier gas mixture.

The fluid flow channel contains an inlet and an outlet and the fluid flow channel is sealed, and vapor impermeable at all portions other than the inlet and the outlet. Thus, substantially all of the sample gas molecules flowing through the fluid flow channel are maintained between the electrodes during the entirety of the time the sample gas molecules flow through the fluid flow channel. The sample molecule/carrier gas mixture is introduced into the fluid flow channel from the inlet.

In some embodiments, the fluid flow channel contains at least one pair of electrodes running lengthwise along one layer of the fluid flow channel. This one layer typically is the inner surface of the fluid flow channel, but it is not limited to the inner surface. When an alternating current is applied to the electrodes, the electrodes are given polarity. Here, a positive (+) electrode is considered as an anode and a negative (−) electrode can be regarded as a cathode, like in an electrolytic cell. Electrons enter between the electrodes from the cathode and exit through the anode. This generates an electrical field between the electrodes, approximately orthogonal to a fluid flow direction of the fluid flow channel. While the alternating current is applied to the electrodes, the sample molecule/carrier gas mixture flows from the fluid flow channel inlet to the fluid flow channel outlet, resulting the sample molecule transported by the carrier gas to migrate between the electrodes.

The behavior of a sample molecule A which migrates in the electric field generated between the electrodes is described hereafter. While a positive voltage is applied by the alternating current power supply, a positive electrode (+) side of the fluid flow channel attracts molecule A, due to an electrostatic interaction between molecule A and the generated electric field, resulting molecule A to approach the positive electrode (+) side. When a negative voltage is applied by the alternating current power supply, a negative electrode (−) side of the fluid flow channel repulse molecule A due to repulsion from the generated electric field, resulting molecule A to migrate away from the fluid flow channel. Because the attraction and repulsion alternate, by alternately applying positive and negative voltages with the alternating current power supply as described above, molecule A migrates through the column in a zigzag manner between the electrodes. Thus, by applying the alternating current to the electrodes, the migration of the sample molecules can be controlled.

Upon exit of the sample molecules from the fluid flow channel, the sample molecules are detected. For example, a molecule detector which includes a resistor circuit, fluidly coupled to gas outlet port, is used to detect the sample molecules. An integrated circuit is coupled to the resistor circuit, which is used to evaluate changes in the current and voltage detected by the resistor circuit, at the time of collision of the sample molecules to the resistor circuit, in order to compute retention times of the sample molecules. From the evaluation result, it is possible to identify the sample molecules.

In some embodiments, in identifying a plurality of sample molecules, the sample molecules are identified based on retention times from the start of measurement to detection by gas molecule detector derived from the electric current measurement. In order to attribute an arbitrary peak to a chemical material, reference values of individual chemical materials are obtained. In some embodiments, it is possible to store the results as reference data, and comparing measurement data with the reference data. Measurement results of one or more kinds of samples may be used to create a database of peak detection times of a plurality of chemical materials. Chemical materials can then be identified by comparing retention times observed at measurement with the peak detection times in the database.

In some embodiments, it is possible to adjust the frequency of an alternating current, such as a low frequency for sample molecules with a low dipole moment and a high frequency for sample molecules with a high dipole moment. By adjusting the frequency of the alternating current according to a frequency of the sample molecules, it is possible to adjust the balance between improvement in measurement precision and reduction in measurement time.

In some embodiments, it is possible to transmit result data obtained through calculation and evaluation in the detection to an external server. The data can be transmitted either wirelessly or via wire. This transmission allows the result data for post-hoc examination and analysis remotely conducted.

### EXAMPLES

Additional embodiments are disclosed in further detail in the following examples, which are not in any way intended to limit the scope of the claims.

### Example 1

### Constructing a Miniaturized Gas Chromatograph

For construction of a miniaturized gas chromatograph, a semiconductor chip having the dimensions as: length—about 250 μm or less; width—about 250 μm or less; and thickness—about 50 μm or less is manufactured using semiconductor device fabrication technology, such as microelectromechanical system (MEMS) technology.

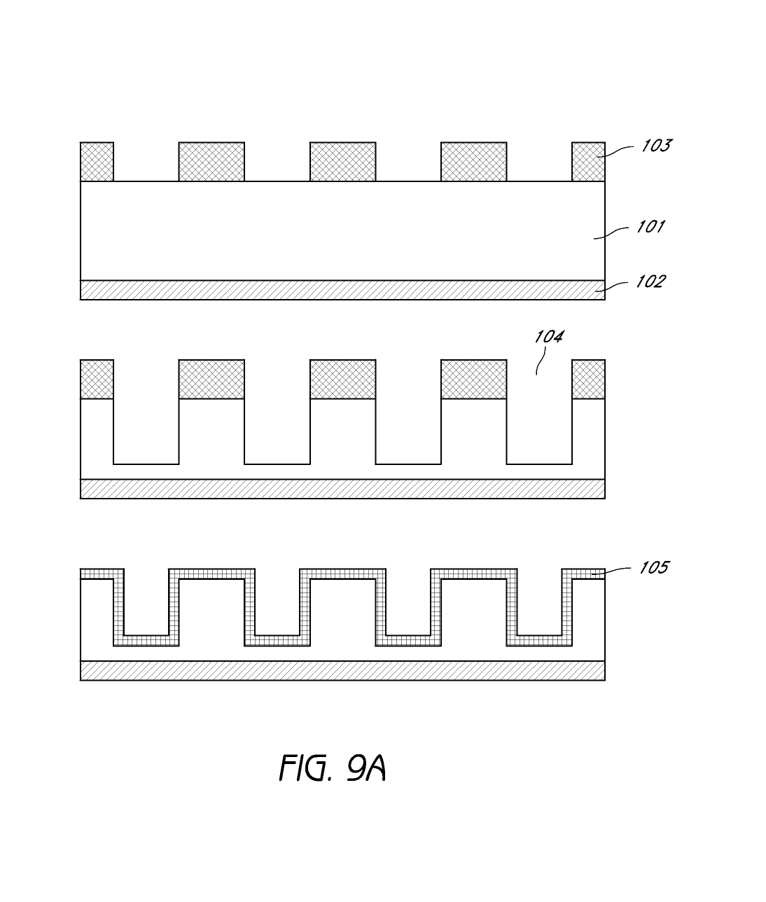

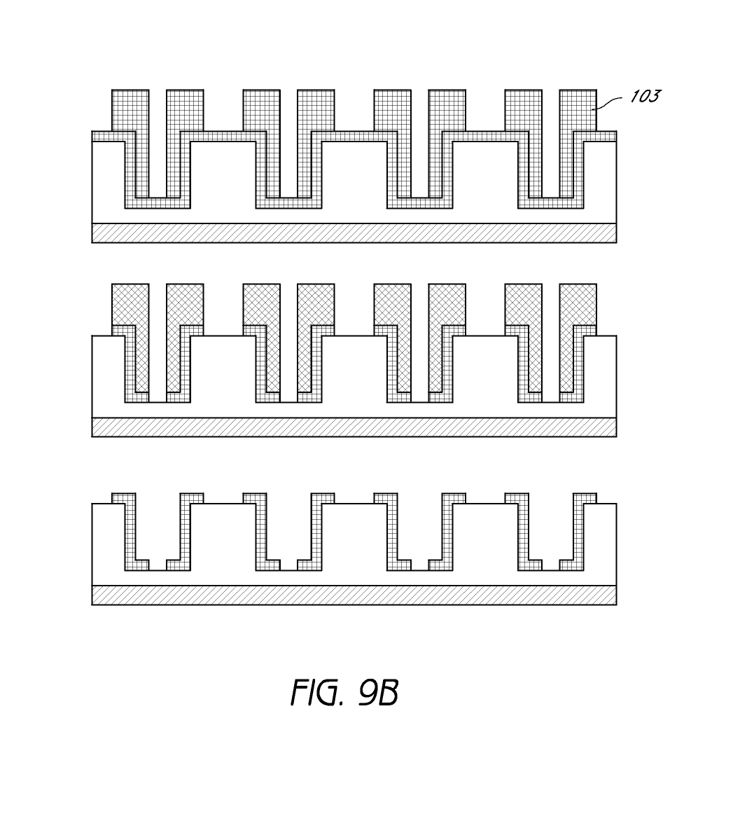

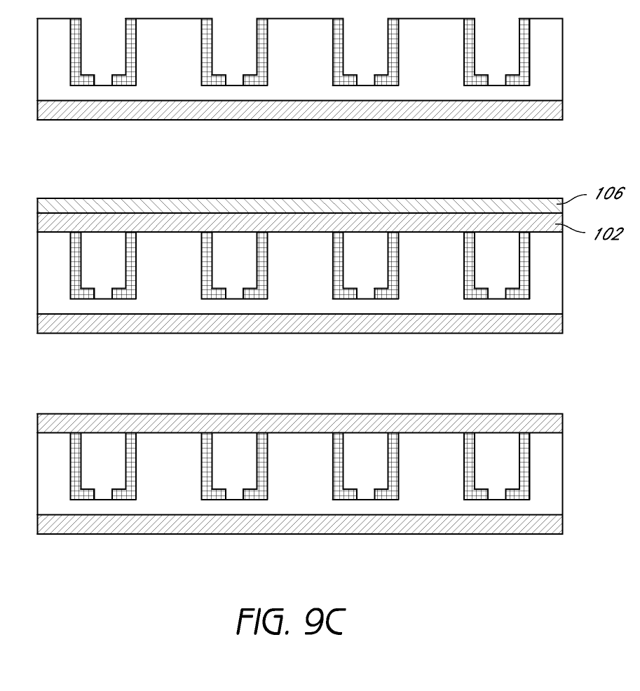

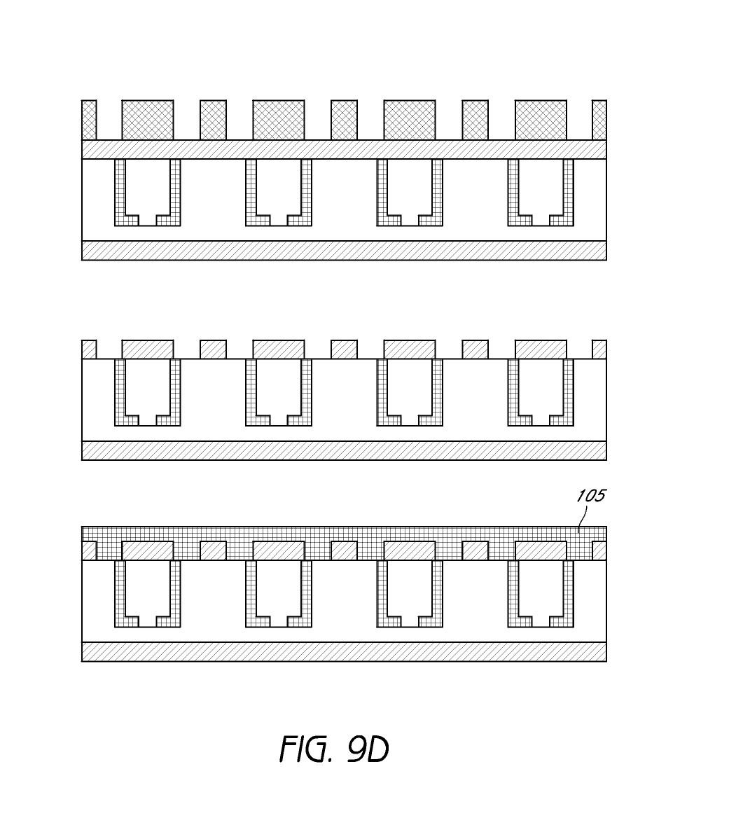

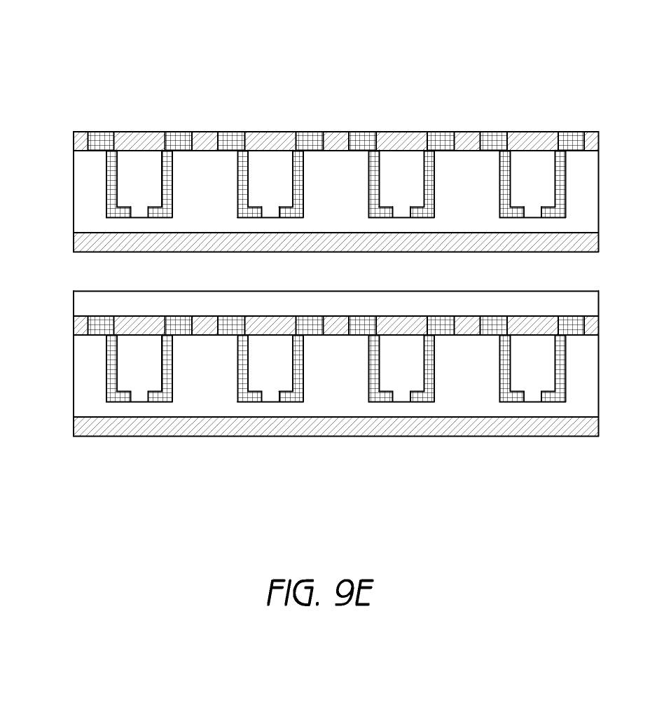

FIGS. 9A-9E illustrate one embodiment of manufacturing steps of the column. For example, as shown in FIG. 9A, it is possible to have an insulator film 101 deposited on a silicon substrate wafer 102, by physical vapor deposition (PVD), CVD, ALD, vacuum deposition, or sputtering. After the film deposition, a pattern of a column including an inlet and an outlet 103 is patterned on the film using lithography. Dry or wet etching to remove some portions of the film 104 is executed to form the column on the substrate. Thus, the column having a length of about 5,000 μm in a shape of two-dimensional Archimedean spiral is formed on the semiconductor chip. After the column is formed, a metal film 105 for electrodes is deposited on an inner surface of the column by PVD, CVD, ALD, vacuum deposition, sputtering of a metal coating, or electroplating. The deposited metal film is then defined with the following lithography process and (dry or wet) etching, and ashing, as shown in FIG. 9B. Thus, one pair of electrodes is defined in each column.

After the electrodes definition, the surface of the films is planarized by chemical mechanical polishing (CMP) as shown in FIG. 9C. After the chemical mechanical polishing, the patterned substrate is sealed to be vapor impermeable at all portions other than the inlet and the outlet by pressing spin-coated insulator layer 102 onto a stretchable film 106 in a vacuum chamber, transferring an insulator layer on the patterned substrate by removing the stretchable film. This method is so called “the spin coating film transfer and hot-pressing (STP) technique.” For example, as shown in FIG. 9D, the vapor impermeable insulator layer is defined and etched to form a first node for connecting one of the electrodes on the inner surface of the column to an alternating current power supply, and a second node for connecting the other of the electrodes on the inner surface to the ground. A metal film 105 is plated and filled with the etched holes. The substrate is chemically and mechanically polished to make the surface to be flat as shown in FIG. 9E. An insulator layer is, then, deposited on the metal film 105 to cover and passivate the surface. The STP technique is described, for example, in two articles by Sato et al., “Advanced spin coating film transfer and hot-pressing process for global planarization with dielectric-material-viscosity control,” Jpn. J. Appl. Phys., (2002) Vol. 41 pp. 2367-23′73, and “Advanced transfer system for spin coating film transfer and hot-pressing in planarization technology”, J. of Vacuum Science & Technology B: Microelectronics and Nanometer Structures, 2002 Vol. 20: Issue: 3 (pp. 797-801).

A molecule detector including a Wheatstone bridge circuit and an integrated circuit (CMOS) portion can be fabricated monolithically on the same semiconductor chip by utilizing the semiconductor fabrication process with MEMS technology, so called “System on Chip (SoC).” A System on Chip may be fabricated by the following steps. First, mechanical devices or electronic circuits are built on (or within) a silicon substrate by deposition or growth of layers of materials. The layers are patterned, etched, implanted and/or polished to create mechanically or electronically distinct regions on one chip. The layers may include a sacrificial layer of material that is removed in the later stages of microfabrication to release movable mechanical structures on the silicon substrate. Thus, the ICs and MEMS components are created in separate areas on one chip in the silicon substrate rather than stacked vertically. Because of design complexity, the SoCs become cost effective with high reliable interconnectivity when the SoCs are mass-produced. Methods of manufacturing the SoCs can be performed according to any such method known in the art, as disclosed in U.S. Patent Publication 2003/0104649 A1 by M. Ozgur et al., or in U.S. Patent Publication 2011/0084343 A1 by B. Yeh et al., which are incorporated by reference herein in its entirety.

Alternatively, a molecule detector, a Wheatstone bridge circuit, and an integrated circuit may be fabricated separately on a different substrate, stacked vertically or side-by-side, and integrated in a package by connecting with the wires, bondings, flip chips, bumps, solder balls, called the System in Package (SiP). One example of fabrication of SiP may include the following steps. At the beginning, a first substrate is processed to incompletely define the detector in a first surface of the first substrate. A second substrate is processed to define the circuitry on a surface of the second substrate. The first and second substrates are bonded together, and then the first substrate was etched to complete the detector by removing portions of the first substrate at a second surface of the first substrate opposite the first surface to define a component and by removing portions of the first substrate at the first surface thereof to release the component relative to the second substrate. Because of a plurality of processes on a plurality of substrates to fabricate a plurality of chips in a package, the chips may include the detector which may have a large capacitive sensitivity due to a larger mass allowed than to be implemented with SoC. Thus, SiP provides integration flexibility, short design time, low design complexity and low design cost. Methods of manufacturing the SiP can be performed according to any such method known in the art, as exemplified by U.S. Pat. No. 7,562,573 B2 by N. Yazdi, which is incorporated by reference herein in its entirety.

### Example 2

### Varying the Size of the Miniaturized Gas Chromatograph

A gas chromatograph of different size is manufactured in the same manner as provided in Example 1, where the semiconductor chip has the dimensions as: length—about 500 μm or less; width—about 500 μm or less; and thickness—about 100 μm or less to form an Archimedean spiral-shaped column having a length of 20.0 mm.

### Example 3

### Constructing a Miniaturized Gas Chromatograph with Two Pairs of Electrodes

A gas chromatograph of having two pairs of electrodes is manufactured in the same manner as provided in Example 1, except that after the column is formed, two pairs of electrodes are deposited with on an inner surface of the column by the metal coating.

### Example 4

### Use of a Gas Chromatograph to Separate and Detect Having the Same or Approximately the Same Molecular Mass and Different Degrees of Dipole Moment

Molecules such as nitrous oxide (N₂O), propane (C₃H₈) and carbon dioxide (CO₂), having the same or approximately the same molecular mass and different values of dipole moment (ρ) are separated by applying an alternating current having an arbitrary frequency to electrodes while passing the molecules through a column. Where three cycles of the alternating current is applied to the electrodes, Molecules N₂O, C₃H₈, CO₂ migrate through the column in a zigzag manner between the electrodes due to the alternation between positive and negative voltages with the alternating current power supply.

Molecules N₂O, C₃H₈ and CO₂ have different values of dipole moment 0.166D, 0.0083D, and OD, respectively. Molecule CO₂ with the lowest electronegativity, OD is least subject to perturbation by the electrodes due to its zero dipole moment and therefore migrates the longest distance among the molecules without a zigzag manner. Molecule C₃H₈ with the relatively lower electronegativity, 0.083D is less subject to perturbation by the electrodes due to its lower dipole moment and therefore migrates the longer distance than N₂O, but shorter than CO₂, in a zigzag manner. On the other hand, Molecule N₂O with the highest electronegativity, 0.166D, is subject to highest perturbation by the electrodes and therefore migrates the shortest distance in a zigzag manner among the molecules. As a result, Molecules N₂O, C₃H₈ and CO₂ are separated by the difference in the electronegtivity while migrating through the column in a zigzag manner.

### Example 5

### Use of a Gas Chromatograph to Separate and Detect Molecules Having Different Molecular Masses and the Same Charge, or Having the Same or Approximately the Same Dipole Moment

Molecules ammonia (NH₃), CH₃F and CH₃Cl, having different molecular masses and the same charge, or having the same or approximately the same dipole moment are separated and detected, by measuring a difference in frequency response characteristics of the molecules after applying an alternating current having an arbitrary frequency to electrodes while passing the molecules through a column. Molecules NH₃, CH₃F, and CH₃Cl have molar masses M_{NH3}=17.03 g/mol, M_{CH3F}=34.03 g/mol and M_{CH3Cl}=50.50 g/mol, respectively, while having the same charge or the same or approximately the same dipole moment, 1.847D, 1.85D, and 1.87D, respectively. When Molecules NH₃, CH₃F, and CH₃Cl migrate through a column, Molecule NH₃ with the smallest molecular mass M_{NH3} is most affected by the alternating current while the largest molecule M_{CH3Cl} is least likely to be affected by the alternating current. As a result, the smaller molecule NH₃ tends to migrate in a more amplified zigzag manner relative to the larger molecule CH₃Cl. This difference in migration results in the larger molecule advancing along the column more rapidly than the smaller molecule. Thus, Molecules NH₃, CH₃F and CH₃Cl are separated and detected by using the frequency response characteristics of the molecules to the alternating current.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or at least one and indefinite articles such as “a” or an (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A gas chromatograph comprising
a gas inlet port;
a sealed fluid flow channel containing one or more pairs of electrodes running lengthwise along the inner surface of the fluid flow channel, wherein a first end of the fluid flow channel is in fluid connection with the gas inlet port;
a gas outlet port in fluid connection with a second end of the fluid flow channel; and
a gas molecule detector in fluid connection with the gas outlet port.

2. The gas chromatograph of claim 1, wherein the fluid flow channel is microfabricated on a silicon substrate or a glass substrate.

3. (canceled)

4. The gas chromatograph of claim 1, wherein the fluid flow channel is contained on a chip, wherein the dimensions of the chip are: length—about 500 μm or less; width—about 500 μm or less; and thickness—about 100 μm or less.

5. The gas chromatograph of claim 4, wherein the gas molecule detector also is contained on the chip.

6. The gas chromatograph of claim 1, wherein the fluid flow channel is at least about 1,000 μm in length.

7. The gas chromatograph of claim 1, wherein the fluid flow channel contains two or more pairs of electrodes.

8. The gas chromatograph of claim 1, wherein the fluid flow channel is vapor impermeable at all portions other than the gas inlet port and the gas outlet port.

9. The gas chromatograph of claim 1, wherein the length of the fluid flow channel is at least about 1,000-fold greater than the largest cross-section of the fluid flow channel.

10. The gas chromatograph of claim 1, wherein fluid flow channel is two-dimensionally spirally shaped.

11. The gas chromatograph of claim 1, wherein the pair of electrodes is configured such that, when an alternating current is applied to the pair of electrodes, the migration pattern of a charged or polar molecule along the fluid flow channel is lengthened relative to the migration pattern of the charged or polar molecule along the fluid flow channel when no alternating current is applied to the pair of electrodes.

12. The gas chromatograph of claim 1, wherein the pair of electrodes is configured such that, when an alternating current is applied to the pair of electrodes, the migration pattern of a charged or polar molecule along the fluid flow channel is lengthened relative to the migration pattern of an uncharged, non-polar molecule under the same conditions.

13. The gas chromatograph of claim 1, wherein at least one of the electrodes is a metal electrode.

14. The gas chromatograph of claim 1, further comprising a sample inlet port attached via a valve to the gas inlet port at a location upstream of the fluid flow channel.

15. The gas chromatograph of claim 1, further comprising a carrier gas inlet port attached to the gas inlet port at a location upstream of the sample inlet port.

16. (canceled)

17. A method of separating gas molecules in a sample, the method comprising:
providing a sample containing sample gas molecules;
contacting at least a portion of the sample and a carrier gas to form a sample/carrier gas mixture;
introducing the sample/carrier gas mixture into a fluid flow channel containing an inlet and an outlet, wherein the fluid flow channel contains at least one pair of electrodes running lengthwise along the inner surface of the fluid flow channel;
applying an alternating current to the electrodes running lengthwise along the inner surface of the fluid flow channel;
flowing the sample/carrier gas mixture from the fluid flow channel inlet to the fluid flow channel outlet while the alternating current is applied to the electrodes; and
detecting the presence of sample gas molecules exiting the fluid flow channel outlet.

18. The method of claim 17, whereby the sample gas molecules can be separated according to their polarity, charged state, or both their polarity and charged state.

19. The method of claim 17, whereby polar and/or charged sample gas molecules can be separated according to their molecular weight.

20. The method of claim 17, wherein the alternating current generates an electrical field approximately orthogonal to a fluid flow direction of the fluid flow channel.

21. The method of claim 17, wherein the alternating current varies as the sample/carrier gas mixture flows through the fluid flow channel.

22. The method of claim 17, wherein substantially all sample gas molecules introduced to the fluid flow channel are detected.

23. The method of claim 17, wherein substantially all of the sample gas molecules flowing through the fluid flow channel are maintained between the electrodes during the entirety of the time the sample gas molecules flow through the fluid flow channel.

24. (canceled)

25. (canceled)

26. (canceled)

27. The method of claim 17, further comprising adjusting the frequency of the alternating current voltage while at least a portion of the sample gas molecules are present in the fluid flow channel.

28. A method of producing a gas chromatograph, the method comprising:
providing a substrate;
etching a channel in the substrate, wherein the channel includes an inlet and an outlet;
depositing one or more pairs of electrodes on an inner surface of the channel; and
sealing the channel.

29.-32. (canceled)
